(19) United States
(12) Patent Application Publication
(10) Pub. No.: US 2021/0383154 A1
(43) Pub. Date: Dec. 9, 2021

(54) IMAGE PROCESSING METHOD AND APPARATUS, ELECTRONIC DEVICE AND STORAGE MEDIUM

(71) Applicant: SHENZHEN SENSETIME TECHNOLOGY CO., LTD., Shenzhen (CN)

(72) Inventors: Chenghan LI, Shenzhen (CN); Ziwei LIU, Shenzhen (CN); Lingyun WU, Shenzhen (CN); Ping LUO, Shenzhen (CN)

(73) Assignee: SHENZHEN SENSETIME TECHNOLOGY CO., LTD., Shenzhen (CN)

(21) Appl. No.: 17/445,610

(22) Filed: Aug. 22, 2021

Related U.S. Application Data
(63) Continuation of application No. PCT/CN2019/107854, filed on Sep. 25, 2019.

(30) Foreign Application Priority Data
May 24, 2019 (CN) 201910441976.5

(51) Int. Cl. G06K 9/46; G06K 9/62; G06T 7/90; G06N 3/08; G06K 9/00

(52) U.S. Cl. CPC G06K 9/4652; G06K 9/6256; G06T 7/90; G06K 9/00268; G06N 3/084; G06K 9/4642; G06K 9/6289; G06K 9/4671

(57) ABSTRACT

An image processing method includes: a color feature extracted from a first image is acquired; a customized mask feature is acquired, the customized mask feature being configured to indicate a regional position of the color feature in the first image; and the color feature and the customized mask feature are input to a feature mapping network to perform image attribute edition to obtain a second image.

### CROSS-REFERENCE TO RELATED APPLICATIONS

This is a continuation of International Patent Application No. PCT/CN2019/107854 filed on Sep. 25, 2019, which claims priority to Chinese Patent Application No. 201910441976.5 filed on May 24, 2019. The disclosures of these applications are hereby incorporated by reference in their entirety.

### BACKGROUND

In image processing, modeling and modifying a facial attribute is always an issue of concern in computer vision. On one hand, facial attribute is a dominant visual attribute in the daily life of a user. On the other hand, manipulation of the facial attribute plays an important role in many fields, for example, automatic face edition. However, facial attribute edition does not support more attribute changes and interactive attribute customization of a user. Consequently, the degree of freedom for facial appearance edition is low, a facial appearance may be changed in a limited range, and edition requirements of more changes of the facial appearance and a higher degree of freedom are not met.

### SUMMARY

The disclosure relates generally to the field of image edition, and more specifically to an image processing method and apparatus, an electronic device and a storage medium.

The disclosure provides a technical solution for image processing.

According to an aspect of the disclosure, an image processing method is provided, which may include the following operations.

A color feature extracted from a first image is acquired.

A customized mask feature is acquired, the customized mask feature being configured to indicate a regional position of the color feature in the first image.

The color feature and the customized mask feature are input to a feature mapping network to perform image attribute edition to obtain a second image.

According to an aspect of the disclosure, an image processing apparatus is provided, which may include a first feature acquisition module, a second feature acquisition module and an edition module.

The first feature acquisition module may be configured to acquire a color feature extracted from a first image.

The second feature acquisition module may be configured to acquire a customized mask feature, the customized mask feature being configured to indicate a regional position of the color feature in the first image.

The edition module may be configured to input the color feature and the customized mask feature to a feature mapping network to perform image attribute edition to obtain a second image.

According to an aspect of the disclosure, an electronic device is provided, which may include a processor and a memory. The memory is configured to store instructions executable for the processor. The processor may be configured to execute the image processing method.

According to an aspect of the disclosure, a computer-readable storage medium is provided, in which computer program instructions may be stored, the computer program instructions being executed by a processor to implement the image processing method.

It is to be understood that the above general description and the following detailed description are only exemplary and explanatory and not intended to limit the disclosure.

According to the following detailed descriptions made to exemplary embodiments with reference to the drawings, other features and aspects of the disclosure may become clear.

### BRIEF DESCRIPTION OF THE DRAWINGS

The accompanying drawings, which are incorporated in and constitute a part of this specification, illustrate embodiments consistent with the disclosure and, together with the specification, serve to describe the technical solutions of the disclosure.

FIG. 1 is a flowchart of an image processing method according to embodiments of the disclosure.

FIG. 2 is a flowchart of an image processing method according to embodiments of the disclosure.

FIG. 3 is a schematic diagram of a first training process according to embodiments of the disclosure.

FIG. 4 is a composition diagram of a dense mapping network according to embodiments of the disclosure.

FIG. 5 is a schematic diagram of a second training process according to embodiments of the disclosure.

FIG. 6 is a block diagram of an image processing apparatus according to embodiments of the disclosure.

FIG. 7 is a block diagram of an electronic device according to embodiments of the disclosure.

FIG. 8 is a block diagram of an electronic device according to embodiments of the disclosure.

### DETAILED DESCRIPTION

According to an aspect of the disclosure, an image processing method is provided, which may include the following operations.

A color feature extracted from a first image is acquired.

A customized mask feature is acquired, the customized mask feature being configured to indicate a regional position of the color feature in the first image.

The color feature and the customized mask feature are input to a feature mapping network to perform image attribute edition to obtain a second image.

With adoption of the disclosure, image attribute edition is performed on the color feature and a mask feature (the customized mask feature) indicating the regional position of the color feature in the first image through the feature mapping network, so that more attribute changes and interactive attribute customization of a user may be supported, and the second image obtained by edition meets edition requirements of more changes of a facial appearance and a higher degree of freedom.

In a possible implementation mode, the feature mapping network may be a feature mapping network obtained by training.

A training process for the feature mapping network may include the following operations.

A data pair formed by first image data and a mask feature corresponding to the first image data is determined as a training dataset.

The training dataset is input to the feature mapping network, a color feature of at least one block in the first image data is mapped to the corresponding mask feature in the feature mapping network to output second image data, a loss function is obtained according to the second image data and the first image data, generative adversarial processing is performed through back propagation of the loss function, and the training process is ended when the feature mapping network converges.

With adoption of the disclosure, the feature mapping network is trained by inputting the data pair formed by the first image data and the mask feature corresponding to the first image data, and image attribute edition is performed according to the feature mapping network obtained by training, so that more attribute changes and interactive attribute customization of the user may be supported, and the second image obtained by edition meets the edition requirements of more changes of the facial appearance and the higher degree of freedom.

In a possible implementation mode, the operation that the color feature of the at least one block in the first image data is mapped to the corresponding mask feature in the feature mapping network to output the second image data may include the following operations.

The color feature of the at least one block and the corresponding mask feature are input to a feature fusion encoding module in the feature mapping network.

The color feature provided by the first image data and a spatial feature provided by the corresponding mask feature are fused through the feature fusion encoding module to obtain a fused image feature configured to represent the spatial and color features.

The fused image feature and the corresponding mask feature are input to an image generation part to obtain the second image data.

With adoption of the disclosure, the color feature provided by the first image data and the corresponding mask feature may be input to the feature fusion encoding module to obtain the fused image feature configured to represent the spatial and color features. Since the fused image feature fuses the spatial perception and color features, the second image obtained according to the fused image feature, the corresponding mask feature and the image generation part may meet the edition requirements of more changes of the facial appearance and the higher degree of freedom.

In a possible implementation mode, the operation that the fused image feature and the corresponding mask feature are input to the image generation part to obtain the second image data may include the following operations.

The fused image feature is input to the image generation part. The fused image feature is transformed to a corresponding affine parameter through the image generation part. The affine parameter includes a first parameter and a second parameter.

The corresponding mask feature is input to the image generation part to obtain a third parameter.

The second image data is obtained according to the first parameter, the second parameter and the third parameter.

With adoption of the disclosure, the corresponding affine parameter (the first parameter and the second parameter) is obtained according to the fused image feature, and then the second image data may be obtained in combination with the third parameter obtained according to the corresponding mask feature. Since the fused image feature is considered and the corresponding mask feature is further combined for training, the obtained second image may support more changes of the facial appearance.

In a possible implementation mode, the method may further include the following operation.

The mask feature, corresponding to the first image data, in the training dataset is input to a mask variational encoding module to perform training to output two sub mask changes.

With adoption of the disclosure, the sub mask changes may be obtained through the mask variational encoding module, and then learning may be performed based on the sub mask changes to implement simulation training for face edition processing better.

In a possible implementation mode, the operation that the mask feature, corresponding to the first image data, in the training dataset is input to the mask variational encoding module to perform training to output the two sub mask changes may include the following operations.

A first mask feature and a second mask feature are obtained from the training dataset, the second mask feature being different from the first mask feature.

Encoding processing is performed through the mask variational encoding module to map the first mask feature and the second mask feature to a preset feature space respectively to obtain a first intermediate variable and a second intermediate variable, the preset feature space being lower than the first mask feature and the second mask feature in dimension.

Two third intermediate variables corresponding to the two sub mask changes are obtained according to the first intermediate variable and the second intermediate variable.

Decoding processing is performed through the mask variational encoding module to transform the two third intermediate variables to the two sub mask changes.

With adoption of the disclosure, encoding processing and decoding processing may be performed through the mask variational encoding module to obtain the two sub mask changes, so that simulation training for face edition processing may be implemented better by use of the two sub mask changes.

In a possible implementation mode, the method may further include a simulation training process for face edition processing.

The simulation training process may include the following operations.

The mask feature corresponding to the first image data in the training dataset is input to the mask variational encoding module to output the two sub mask changes.

The two sub mask changes are input to two feature mapping networks respectively, the two feature mapping networks sharing a group of shared weights, and weights of the feature mapping networks are updated to output two pieces of image data.

Fused image data obtained by fusing the two pieces of image data is determined as the second image data, a loss function is obtained according to the second image data and the first image data, generative adversarial processing is performed through back propagation of the loss function, and the simulation training process is ended when the network converges.

With adoption of the disclosure, in the simulation training process for face edition processing, the obtained two sub mask changes may be input to the feature mapping networks sharing the group of shared weights respectively to obtain the generated second image data, and a loss of the second image data and the first image data (real image data of a real world) may be obtained to improve the accuracy of face edition processing to be close to the real image data, so that the second image data generated through the customized mask feature may meet the edition requirements of more changes of the face appearance and the higher degree of freedom better.

According to an aspect of the disclosure, an image processing apparatus is provided, which may include a first feature acquisition module, a second feature acquisition module and an edition module.

The first feature acquisition module may be configured to acquire a color feature extracted from a first image.

The second feature acquisition module may be configured to acquire a customized mask feature, the customized mask feature being configured to indicate a regional position of the color feature in the first image.

The edition module may be configured to input the color feature and the customized mask feature to a feature mapping network to perform image attribute edition to obtain a second image.

In a possible implementation mode, the feature mapping network may be a feature mapping network obtained by training.

The apparatus may further include a first processing module and a second processing module.

The first processing module may be configured to determine a data pair formed by first image data and a mask feature corresponding to the first image data as a training dataset.

The second processing module may be configured to input the training dataset to the feature mapping network, map, in the feature mapping network, a color feature of at least one block in the first image data to the corresponding mask feature to output second image data, obtain a loss function according to the second image data and the first image data, perform generative adversarial processing through back propagation of the loss function, and end a training process of the feature mapping network when the network converges.

In a possible implementation mode, the second processing module may further be configured to: input the color feature of the at least one block and the corresponding mask feature to a feature fusion encoding module in the feature mapping network; fuse the color feature provided by the first image data and a spatial feature provided by the corresponding mask feature through the feature fusion encoding module to obtain a fused image feature configured to represent the spatial and color features; and input the fused image feature and the corresponding mask feature to an image generation part to obtain the second image data.

In a possible implementation mode, the second processing module may further be configured to: input the fused image feature to the image generation part, transform, through the image generation part, the fused image feature to a corresponding affine parameter, the affine parameter including a first parameter and a second parameter; input the corresponding mask feature to the image generation part to obtain a third parameter; and obtain the second image data according to the first parameter, the second parameter and the third parameter.

In a possible implementation mode, the device may further include a third processing module, configured to: input the mask feature corresponding to the first image data in the training dataset to a mask variational encoding module to perform training to output two sub mask changes.

In a possible implementation mode, the third processing module may further be configured to: obtain a first mask feature and a second mask feature from the training dataset, the second mask feature being different from the first mask feature; perform encoding processing through the mask variational encoding module to map the first mask feature and the second mask feature to a preset feature space respectively to obtain a first intermediate variable and a second intermediate variable, the preset feature space being lower than the first mask feature and the second mask feature in dimension; obtain, according to the first intermediate variable and the second intermediate variable, two third intermediate variables corresponding to the two sub mask changes; and perform decoding processing through the mask variational encoding module to transform the two third intermediate variables to the two sub mask changes.

In a possible implementation mode, the apparatus may further include a fourth processing module, configured to: input the mask feature corresponding to the first image data in the training dataset to the mask variational encoding module to output the two sub mask changes; input the two sub mask changes to two feature mapping networks respectively, the two feature mapping networks sharing a group of shared weights, and update weights of the feature mapping networks to output two pieces of image data; determine fused image data obtained by fusing the two pieces of image data as the second image data, obtain a loss function according to the second image data and the first image data, perform generative adversarial processing through back propagation of the loss function, and end a simulation training process for face edition processing when the feature mapping network converges.

According to an aspect of the disclosure, an electronic device is provided, which may include a processor and a memory. The memory is configured to store instructions executable for the processor.

The processor may be configured to execute the image processing method.

According to an aspect of the disclosure, a computer-readable storage medium is provided, in which computer program instructions may be stored, the computer program instructions being executed by a processor to implement the image processing method.

In the disclosure, the color feature extracted from the first image is acquired; the customized mask feature is acquired, the customized mask feature being configured to indicate the regional position of the color feature in the first image; and the color feature and the customized mask feature are input to the feature mapping network, and image attribute edition is performed to obtain the second image. With adoption of the disclosure, the regional position of the color feature in the first image may be specified through the customized mask feature. Since more attribute changes and interactive attribute customization of a user are supported, the second image obtained by performing image attribute edition through the feature mapping network meets the edition requirements of more changes of the facial appearance and the higher degree of freedom.

It is to be understood that the above general description and the following detailed description are only exemplary and explanatory and not intended to limit the disclosure.

Each exemplary embodiment, feature and aspect of the disclosure will be described below with reference to the drawings in detail. The same reference signs in the drawings represent components with the same or similar functions. Although each aspect of the embodiments is shown in the drawings, the drawings are not required to be drawn to scale, unless otherwise specified.

Herein, special term “exemplary” refers to “use as an example, embodiment or description”. Herein, any “exemplarily” described embodiment may not be explained to be superior to or better than other embodiments.

In the disclosure, term “and/or” is only an association relationship describing associated objects and represents that three relationships may exist. For example, A and/or B may represent three conditions: i.e., independent existence of A, existence of both A and B and independent existence of B. In addition, term “at least one” in the disclosure represents any one of multiple or any combination of at least two of multiple. For example, including at least one of A, B and C may represent including any one or more elements selected from a set formed by A, B and C.

In addition, for describing the disclosure better, many specific details are presented in the following specific implementation modes. It is understood by those skilled in the art that the disclosure may still be implemented even without some specific details. In some examples, methods, means, components and circuits known very well to those skilled in the art are not described in detail, to highlight the subject of the disclosure.

Modeling and modifying a facial attribute is always an issue of concern in computer vision. On one hand, facial attribute is a dominant visual attribute in people's daily lives. On the other hand, manipulation of the facial attribute plays an important role in many fields, for example, automatic face edition. However, facial attribute edition work mostly focuses on semantic-level facial attribute edition such as hair or skin color edition. In addition, semantic-level attribute edition is low in degree of freedom, and consequently, interactive face edition with many changes may not be implemented. The disclosure provides a technical solution capable of implementing interactive face edition based on a geometric orientation of a facial attribute. The geometric orientation simply refers to regulation of a certain regional position in an image. For example, for an unsmiling face in an image, a regional position thereof may be regulated to obtain an image with a smiling face. This is an example of regulation of the regional position.

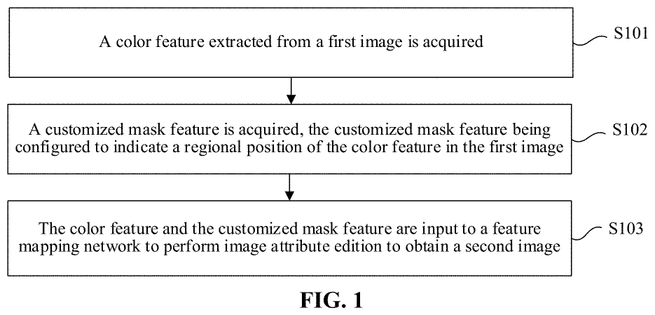

FIG. 1 is a flowchart of an image processing method according to embodiments of the disclosure. The image processing method is applied to an image processing apparatus. For example, the image processing method may be executed by a terminal device or a server or another processing device. The terminal device may be User Equipment (UE), a mobile device, a cell phone, a cordless phone, a Personal Digital Assistant (PDA), a handheld device, a computing device, a vehicle device, a wearable device and the like. In some possible implementation modes, the image processing method may be implemented in a manner that a processor calls computer-readable instructions stored in a memory. As shown in FIG. 1, the flow includes the following operations.

In S101, a color feature extracted from a first image is acquired.

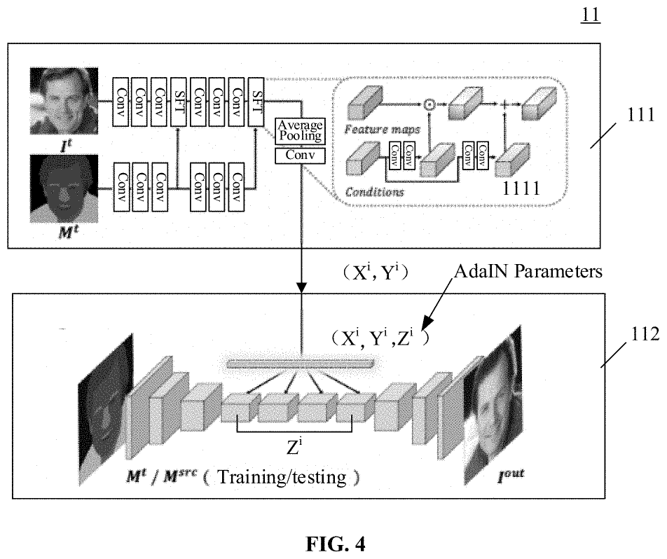

Facial attribute edition may include semantic-level attribute edition and geometry-level attribute edition. Semantic-level attribute edition is for, for example, a color of the hair, a skin color, makeup and the like. Geometry-level attribute edition is for, for example, a customized shape, a position of the hair and a smiling or unsmiling expression, for example, a mask feature M^{src} in FIG. 4.

In S102, a customized mask feature is acquired, the customized mask feature (for example, the mask feature M^{src} in FIG. 4) being configured to indicate a regional position of the color feature in the first image.

In S103, the color feature and the customized mask feature are input to a feature mapping network (for example, a dense mapping network) to perform image attribute edition to obtain a second image.

In the disclosure, the color feature represents a semantic attribute of the image. The semantic attribute represents a specific content of an image attribute, for example, the color of the hair, the skin color, the makeup and the like. The mask feature is configured to identify the regional position, or called a regional shape, specified by the color feature in the image. The mask feature may adopt an existing feature in a dataset, and may also be customized based on the existing feature in the dataset, called the “customized mask feature”, namely the regional position of the color feature in the image may be specified according to a configuration of a user. The mask feature represents a geometric attribute of the image. The geometric feature represents a position of the image attribute, for example, the position of the hair in the face image and the smiling or unsmiling expression in the face image. For example, the mask feature M^{src} in FIG. 4 in the disclosure is the customized mask feature. The feature mapping network is configured to densely map a color feature of a target image (the first image) and the customized mask feature (the geometric attribute is added in image attribute edition, namely customized edition, for example, changing a smiling expression in the first image to an unsmiling expression in the second image, is performed in the second image to change a regional shape and/or position in the first image), thereby obtaining any customized face image that the user wants. The feature mapping network may be a trained dense mapping network obtained by training a dense mapping network. With adoption of the disclosure, for facial attribute edition, the mask feature may be customized according to the configuration of the user, so that more attribute changes for face edition are added, the user is supported to implement attribute customization processing in an interaction manner and is not limited to adopt an existing attribute, the degree of freedom for facial appearance edition is improved, and a required target image may be obtained based on a customized mask. Universality for facial appearance changes is achieved, the application range is wider, and edition requirements of more changes of the facial appearance and a higher degree of freedom are met.

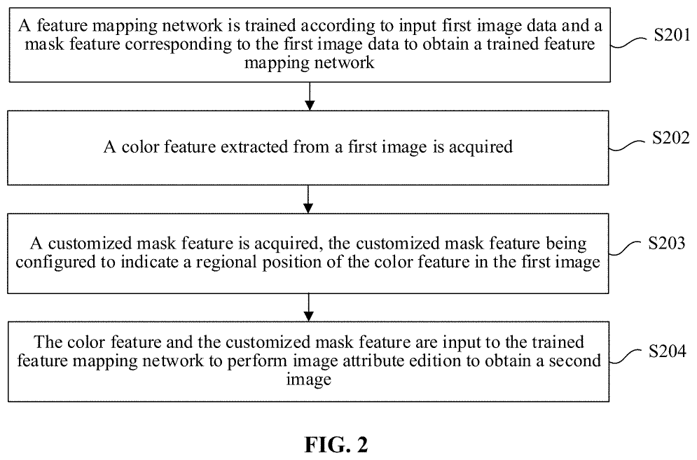

FIG. 2 is a flowchart of an image processing method according to embodiments of the disclosure. As shown in FIG. 2, the following operations are included.

In S201, a feature mapping network is trained according to an input data pair (first image data and a mask feature corresponding to the first image data) to obtain a trained feature mapping network.

A training process for the feature mapping network includes the following operations. The data pair formed by the first image data and the mask feature corresponding to the first image data is determined as a training dataset. The training dataset is input to the feature mapping network. A color feature of at least one block in the first image data is mapped to the corresponding mask feature in the feature mapping network to output second image data. A loss function is obtained according to the second image data and the first image data (which is different from the generated second image data and is the real image data in a real world), generative adversarial processing is performed through back propagation of the loss function, and the training process is ended when the network converges.

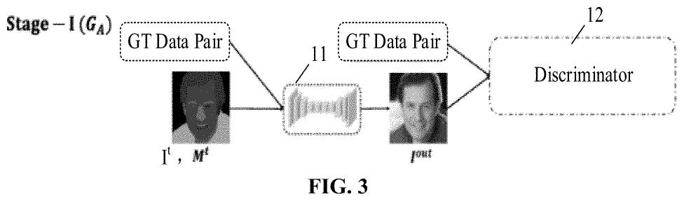

FIG. 3 is a schematic diagram of a first training process according to embodiments of the disclosure. As shown in FIG. 3, in a stage I of training (training for the dense mapping network), the data pair is input to the feature mapping network (for example, the dense mapping network) 11. There are multiple data pairs, and the multiple data pairs form the training dataset configured to train the feature mapping network (for example, the dense mapping network). For simplified description, “multiple” is not emphasized herein. The data pair is formed by the first image data (for example, I^{t}) and the mask feature (M^{t}) corresponding to the first image data. For example, the training dataset is input to the dense mapping network, the color feature of the at least one block in the first image data is mapped to the corresponding mask feature in the dense mapping network to output the second image data (for example, I^{out}), the generated second image data is input to a discriminator 12 for generative adversarial processing, namely the loss function is obtained according to the second image data and the first image data, generative adversarial processing is performed through back propagation of the loss function, and when the network converges, the training process of the dense mapping network is ended.

In S202, a color feature extracted from a first image is acquired.

Facial attribute edition may include semantic-level attribute edition and geometry-level attribute edition. Semantic-level attribute edition is for, for example, a color of the hair, a skin color, makeup and the like. Geometry-level attribute edition is for, for example, a customized shape, a position of the hair and a smiling or unsmiling expression, for example, a mask feature M^{src} in FIG. 4.

In S203, a customized mask feature is acquired, the customized mask feature (for example, the mask feature M^{src} in FIG. 4) being configured to indicate a regional position of the color feature in the first image.

In S204, the color feature and the customized mask feature are input to the trained feature mapping network (for example, a trained dense mapping network), and image attribute edition is performed to obtain a second image.

With adoption of the disclosure, a block color pattern of a target image is projected to a corresponding mask by training learning through the dense mapping network. The dense mapping network provides an edition platform for a user and enables the user to edit a mask to change a facial appearance to achieve a higher degree for freedom of edition and implement interactive face edition with many changes. The training dataset for training learning is a large-scale face mask dataset and, compared with a conventional dataset, includes more categories and is larger in order of magnitude. There are totally 30,000 groups and totally 19 categories of which pixel levels are tagged to be 512×512 in the dataset, including all facial parts and accessories.

In a possible implementation mode of the disclosure, the operation that the color feature of the at least one block in the first image data is mapped to the corresponding mask feature in the feature mapping network to output the second image data includes the following operations. The color feature of the at least one block and the corresponding mask feature are input to a feature fusion encoding module in the feature mapping network. The color feature provided by the first image data and a spatial feature provided by the corresponding mask feature are fused through the feature fusion encoding module to obtain a fused image feature configured to represent the spatial and color features. The fused image feature and the corresponding mask feature are input to an image generation part to obtain the second image data. For the fused image feature representing the spatial and color features, the color feature provided by the image and the spatial feature provided by the mask feature are fused to generate the fused image feature with the spatial and color features. In an example, the mask feature may be configured to indicate a specific regional position of a certain color in the image. For example, if a color feature of hair is gold, a regional position of the gold in the image may be obtained through the mask feature, and then the color feature (gold) is fused with the corresponding regional position to obtain the hair filled with the gold in the region in the image.

In a possible implementation mode of the disclosure, the operation that the fused image feature and the corresponding mask feature are input to the image generation part to obtain the second image data includes the following operations. The fused image feature is input to the image generation part. The fused image feature is transformed to a corresponding affine parameter through the image generation part. The affine parameter includes a first parameter (for example, Xⁱ in FIG. 4) and a second parameter (Yⁱ in FIG. 4). The corresponding mask feature is input to the image generation part to obtain a third parameter (for example, Zⁱ in FIG. 4). The second image data is obtained according to the first parameter, the second parameter and the third parameter.

In an example, the feature mapping network is the dense mapping network, the feature fusion encoding module is a Spatial-Aware Style encoder, and the image generation part is an Image Generation Backbone. FIG. 4 is a composition diagram of a dense mapping network according to embodiments of the disclosure. As shown in FIG. 4, the network includes two sub devices: the Spatial-Aware Style encoder 111 and the Image Generation Backbone 112. The Spatial-Aware Style encoder 111 further includes a layer for spatial feature transformation 1111. The Spatial-Aware Style encoder 111 is configured to fuse the mask feature, representing the spatial feature of the image, and the color feature. In other words, the Spatial-Aware Style encoder 111 fuses the color feature provided by the image and the spatial feature provided by the mask feature by use of the layer for spatial feature transformation 1111 to generate the fused image feature. Specifically, the mask feature is configured to indicate a specific regional position of a certain color in the image. For example, if the hair is gold, a regional position of the gold in the image may be obtained through the mask feature, and then the color feature (gold) is fused with the corresponding regional position to obtain the gold hair in the image. The Image Generation Backbone 112 is configured to combine the mask feature and the affine parameter, as input parameters, to obtain a correspondingly generated face image I^{out}. In other words, the Image Generation Backbone 112 transforms the fused image feature to the affine parameter thereof (Xⁱ, Yⁱ) by using adaptive instance normalization, such that the input mask feature may be combined with the color feature to generate the corresponding face image, and the color feature of the target image and the input mask may finally form dense mapping.

The parameters “AdaIN Parameters” in FIG. 4 are parameters obtained by inputting the training dataset to the dense mapping network, for example, parameters obtained through the layer for spatial feature transformation 1111 after I^{t} and M^{t} are input. AdaIN Parameters may be (Xⁱ, Yⁱ, Zⁱ), where Xⁱ and Yⁱ are affine parameters, and Zⁱ is a feature generated by subjecting the input mask feature M^{t} through the Image Generation Backbone 112, as shown by the four blocks corresponding to the arrows in FIG. 4. Finally, the final output target image I^{out} is obtained according to the affine parameters Xⁱ and Yⁱ obtained by subjecting the input I^{t} and the input M^{t} through the layer for spatial feature transformation 1111 and the feature Zⁱ generated according to the input mask feature M^{t}. In a generative adversarial model, I^{out} generated through a generator and a real image are discriminated in a discriminator. A probability of 1 indicates true, which indicates that the discriminator may not discriminate the generated image and the real image. If the probability is 0, it is indicated that the discriminator may discriminate that the generated image is not the real image, that is, training is required to be continued.

In a possible implementation mode of the disclosure, the method further includes that: the mask feature, corresponding to the first image data, in the training dataset is input to a mask variational encoding module to perform training to output two sub mask changes.

In a possible implementation mode of the disclosure, the operation that the mask feature, corresponding to the first image data, in the training dataset is input to the mask variational encoding module to perform training to output the two sub mask changes includes the following operations. A first mask feature and a second mask feature are obtained from the training dataset, the second mask feature being different from the first mask feature. Encoding processing is performed through the mask variational encoding module to project the first mask feature and the second mask feature to a preset feature space respectively to obtain a first intermediate variable and a second intermediate variable, the preset feature space being lower than the first mask feature and the second mask feature in dimension. Two third intermediate variables corresponding to the two sub mask changes are obtained according to the first intermediate variable and the second intermediate variable. Decoding processing is performed through the mask variational encoding module to transform the two third intermediate variables to the two sub mask changes.

In an example, a hardware implementation of the mask variational encoding module may be a mask variational auto-encoder 10. The mask feature M^{t} corresponding to the first image data in the training dataset is input to the mask variational auto-encoder 10 to perform training i to output the two sub mask changes M^{inter} and M^{outer}. The mask variational auto-encoder includes two sub devices: an encoder and a decoder. The first mask feature M^{t} and the second mask feature M^{ref} are obtained from the training dataset. Both M^{ref} and M^{t} are mask features extracted from the training dataset, and they are different. Encoding processing is performed through the encoder of the mask variational auto-encoder 10 to project the first mask feature and the second mask feature to the preset feature space respectively to obtain the first intermediate variable Z^{t} and the second intermediate variable Z^{ref}, the preset feature space being lower than the first mask feature and the second mask feature in dimension. The two third intermediate variables, i.e., Z^{inter} and Z^{outer}, corresponding to the two sub mask changes are obtained according to the first intermediate variable and the second intermediate variable. Decoding processing is performed through the decoder of the mask variational auto-encoder 10 to transform the two third intermediate variables to the two sub mask changes, i.e., M^{inter} and M^{outer}. The processing process executed by the mask variational auto-encoder 10 is correspondingly shown as the following formula (1) to formula (6).

1. An initialization stage: the dense mapping network G_{A} is trained, and the encoder Enc_{VAE} and decoder Dec_{VAE} in the mask variational auto-encoder are trained.

2. The input parameters are the image I^{t}, the first mask feature M^{t} and the second mask feature M^{ref}.

3. The two sub mask changes, i.e., M^{inter} and M^{outer}, are obtained through the specific processing process executed by the mask variational auto-encoder 10.

$$\begin{matrix}\{ {M}_{i}^{t} , {I}_{i}^{t} \} , i = 1 , … , N . & ( 1 ) \\ {z}^{t} = {Enc}_{VAE} ( {M}^{t} ) . & ( 2 ) \\ {z}^{ref} = {Enc}_{VAE} ( {M}^{ref} ) . & ( 3 ) \\ {z}^{inter} , {z}^{outer} = {z}^{t} \pm \frac{{z}^{ref} - {z}^{t}}{{λ}_{inter}} . & ( 4 ) \\ {M}^{inter} = {Dec}_{VAE} ( {z}^{inter} ) . & ( 5 ) \\ {M}^{outer} = {Dec}_{VAE} ( {z}^{outer} ) . & ( 6 )\end{matrix}$$

In the above formulae, {Mᵢ^{t}, Iᵢ^{t}} is the data pair formed by M^{t} and It selected from the training dataset. M^{t} is the first mask feature amd M^{ref} is the second mask feature. Both M^{ref} and M^{t} are mask features extracted from the training dataset, and they are different. Z^{t} is the first intermediate variable, Z^{ref} is the second intermediate variable, and they are two intermediate variables obtained by projecting M^{t} and M^{ref} to the preset feature space respectively. The two third intermediate variables Z^{inter} and Z^{outer} are obtained according to Z^{t} and Z^{ref}, and the two sub mask changes M^{inter} and M^{outer} may be obtained through Z^{inter} and Z^{outer}.

4. Output parameters are face images I^{inter} and I^{outer} correspondingly generated according to the input parameters and a fused image I^{blend} obtained by fusing the face images according to an alpha fusion device 13. Then, generative adversarial processing is performed on the fused image and the discriminator 12, and the first training process and the second training process are continued according to processing in the above contents 2 and 3 to update G_{A}(I^{t}, M^{t}) and G_{B}(I^{t}, M^{t}, M^{inter}, M^{outer}) respectively.

In a possible implementation mode of the disclosure, the method further includes a simulation training process for face edition processing. The simulation training process includes the following operations. The mask feature, corresponding to the first image data, in the training dataset is input to the mask variational encoding module to output the two sub mask changes. The two sub mask changes are input to two feature mapping networks respectively, the two feature mapping networks sharing a group of shared weights, and weights of the feature mapping networks are updated to output two pieces of image data. Fused image data obtained by fusing (through the alpha fusion device) the two pieces of image data is determined as the second image data, the loss function is obtained according to the second image data and the first image data, generative adversarial processing is performed through back propagation of the loss function, and the simulation training process is ended when the network converges.

In an example, complete training is divided into two stages. The dense mapping network and the mask variational auto-encoder are required to be trained at first. The dense mapping network is updated once in the first stage. In the second stage, after the two mask changes are generated by use of the mask variational auto-encoder, the two dense mapping networks sharing the weights and the alpha fusion device are updated.

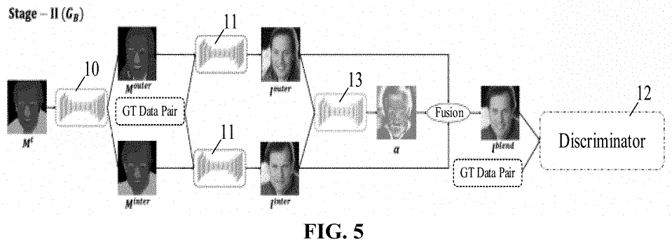

FIG. 5 is a schematic diagram of a second training stage according to embodiments of the disclosure. As shown in FIG. 5, in a stage II of training (user edition simulation training), for improving the robustness of the dense mapping network to mask changes caused by face edition, three modules are required by an adopted training method: the mask variational auto-encoder, the dense mapping network and the alpha fusion device. The mask variational auto-encoder is responsible for simulating a mask edited by the user. The dense mapping network is responsible for transforming the mask to a face and projecting a color pattern of a target face to the mask. The alpha fusion device is responsible for performing alpha fusion on faces generated by subjecting two sets of simulation-edited masks generated by the mask variational auto-encoder through the dense mapping network.

The dense mapping network and the mask variational auto-encoder are trained in the first training stage, and then the dense mapping network and the mask variational auto-encoder are used. Linear interpolation is performed in a hidden space to generate two simulated mask changes (the sub mask changes mentioned above in the disclosure) by use of the mask variational auto-encoder, i.e., adopting the above formula (1) to the formula (6). The dense mapping network may be updated once. Then, in the second stage, the two faces are generated by subjecting the two mask changes generated at the very beginning through the two dense mapping networks sharing the weights, and then are fused through the alpha fusion device. Loss calculation and network updating are performed by use of a fusion result and the target image. The two stages are iterated in turns until the model (for example, the dense mapping network and the mask variational auto-encoder) converges. When the model is tested, even if the mask is greatly edited, retention of the facial attribute (for example, the makeup, the gender, the beard and the like) may still be improved.

It can be understood by those skilled in the art that, in the method of the specific implementation modes, the writing sequence of each operation does not mean a strict execution sequence and is not intended to form any limit to the implementation process and a specific execution sequence of each operation should be determined by functions and probable internal logic thereof.

Each method embodiment mentioned in the disclosure may be combined to form combined embodiments without departing from principles and logics. For saving the space, elaborations are omitted in the disclosure.

In addition, the disclosure also provides an image processing apparatus, an electronic device, a computer-readable storage medium and a program. All of them may be configured to implement any image processing method provided in the disclosure. Corresponding technical solutions and descriptions refer to the corresponding records in the method part and will not be elaborated.

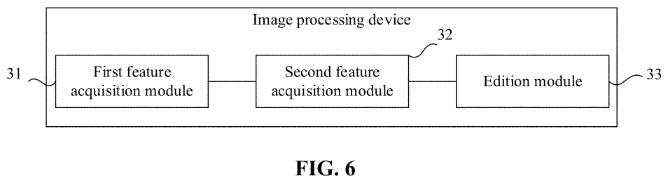

FIG. 6 is a block diagram of an image processing apparatus according to embodiments of the disclosure. As shown in FIG. 6, the image processing apparatus of the embodiment of the disclosure includes: a first feature acquisition module 31, configured to acquire a color feature extracted from a first image; a second feature acquisition module 32, configured to acquire a customized mask feature, the customized mask feature being configured to indicate a regional position of the color feature in the first image; and an edition module, 33 configured to input the color feature and the customized mask feature to a feature mapping network to perform image attribute edition to obtain a second image.

In a possible implementation mode of the disclosure, the feature mapping network is a feature mapping network obtained by training. The apparatus further includes: a first processing module, configured to determine a data pair formed by first image data and a mask feature corresponding to the first image data as a training dataset; and a second processing module, configured to input the training dataset to the feature mapping network, map, in the feature mapping network, a color feature of at least one block in the first image data to the corresponding mask feature to output second image data, obtain a loss function according to the second image data and the first image data, perform generative adversarial processing through back propagation of the loss function and end the training process of the feature mapping network when the network converges.

In a possible implementation mode of the disclosure, the second processing module is further configured to: input the color feature of the at least one block and the corresponding mask feature to a feature fusion encoding module in the feature mapping network; fuse the color feature provided by the first image data and a spatial feature provided by the corresponding mask feature through the feature fusion encoding module to obtain a fused image feature configured to represent the spatial and color features; and input the fused image feature, and the corresponding mask feature to an image generation part to obtain the second image data.

In a possible implementation mode of the disclosure, the second processing module is further configured to: input the fused image feature to the image generation part, transform, through the image generation part, the fused image feature to a corresponding affine parameter, the affine parameter including a first parameter and a second parameter; input the corresponding mask feature to the image generation part to obtain a third parameter; and obtain the second image data according to the first parameter, the second parameter and the third parameter.

In a possible implementation mode of the disclosure, the apparatus further includes a third processing module, configured to input the mask feature corresponding to the first image data in the training dataset to a mask variational encoding module to perform training to output two sub mask changes.

In a possible implementation mode of the disclosure, the third processing module is further configured to: obtain a first mask feature and a second mask feature from the training dataset, the second mask feature being different from the first mask feature; perform encoding processing through the mask variational encoding module to map the first mask feature and the second mask feature to a preset feature space respectively to obtain a first intermediate variable and a second intermediate variable, the preset feature space being lower than the first mask feature and the second mask feature in dimension; obtain, according to the first intermediate variable and the second intermediate variable, two third intermediate variables corresponding to the two sub mask changes; and perform decoding processing through the mask variational encoding module to transform the two third intermediate variables to the two sub mask changes.

In a possible implementation mode of the disclosure, the apparatus further includes a fourth processing module, configured to: input the mask feature corresponding to the first image data in the training dataset to the mask variational encoding module to output the two sub mask changes; input the two sub mask changes to two feature mapping networks respectively, the two feature mapping networks sharing a group of shared weights, and update weights of the feature mapping networks to output two pieces of image data; and determine fused image data obtained by fusing the two pieces of image data as the second image data, obtain the loss function according to the second image data and the first image data, perform generative adversarial processing through back propagation of the loss function and end a simulation training process for face edition processing when the feature mapping network converges.

In some embodiments, functions or modules of the device provided in the embodiments of the disclosure may be configured to execute the method described in the above method embodiments and specific implementation thereof may refer to the descriptions about the method embodiments and, for simplicity, will not be elaborated herein.

The embodiments of the disclosure also disclose a computer-readable storage medium, in which computer program instructions are stored, the computer program instructions being executed by a processor to implement the method. The computer-readable storage medium may be a nonvolatile computer-readable storage medium.

The embodiments of the disclosure disclose an electronic device, which includes a processor and a memory configured to store instructions executable for the processor, the processor being configured for the method.

The electronic device may be provided as a terminal, a server or a device in another form.

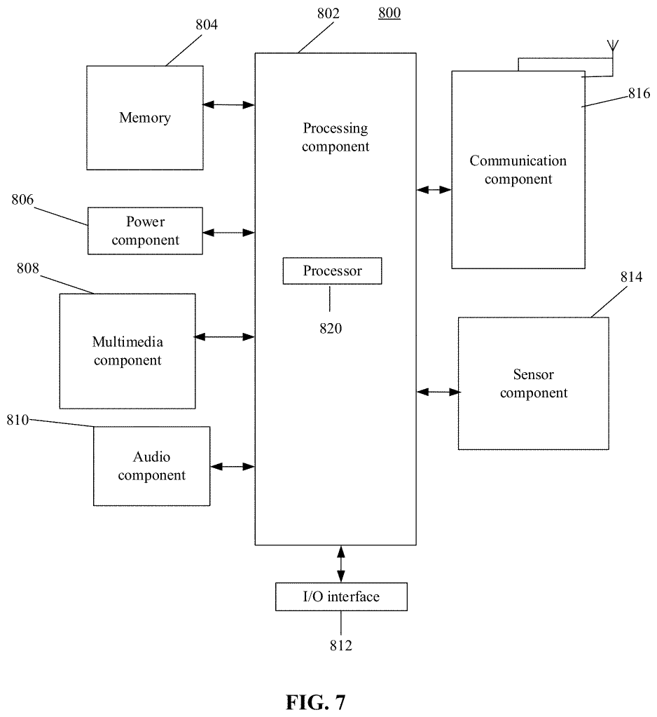

FIG. 7 is a block diagram of an electronic device 800 according to an exemplary embodiment. For example, the electronic device 800 may be a terminal such as a mobile phone, a computer, a digital broadcast terminal, a messaging device, a gaming console, a tablet, a medical device, exercise equipment and a PDA.

Referring to FIG. 7, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the operations in the abovementioned method. Moreover, the processing component 802 may include one or more modules which facilitate interaction between the processing component 802 and the other components. For instance, the processing component 802 may include a multimedia module to facilitate interaction between the multimedia component 808 and the processing component 802.

The memory 804 is configured to store various types of data to support the operation of the electronic device 800. Examples of such data include instructions for any application programs or methods operated on the electronic device 800, contact data, phonebook data, messages, pictures, video, etc. The memory 804 may be implemented by a volatile or nonvolatile storage device of any type or a combination thereof, for example, a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or an optical disk.

The power component 806 provides power for various components of the electronic device 800. The power component 806 may include a power management system, one or more power supplies, and other components associated with generation, management and distribution of power for the electronic device 800.

The multimedia component 808 includes a screen providing an output interface between the electronic device 800 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. The touch sensors may not only sense a boundary of a touch or swipe action but also detect a duration and pressure associated with the touch or swipe action. The front camera and/or the rear camera may receive external multimedia data when the electronic device 800 is in an operation mode, such as a photographing mode or a video mode. Each of the front camera and the rear camera may be a fixed optical lens system or have focusing and optical zooming capabilities.

The audio component 810 is configured to output and/or input an audio signal. For example, the audio component 810 includes a Microphone (MIC), and the MIC is configured to receive an external audio signal when the electronic device 800 is in the operation mode, such as a call mode, a recording mode and a voice recognition mode. The received audio signal may further be stored in the memory 804 or sent through the communication component 816. In some embodiments, the audio component 810 further includes a speaker configured to output the audio signal.

The I/O interface 812 provides an interface between the processing component 802 and a peripheral interface module, and the peripheral interface module may be a keyboard, a click wheel, a button and the like. The button may include, but not limited to: a home button, a volume button, a starting button and a locking button.

The sensor component 814 includes one or more sensors configured to provide status assessment in various aspects for the electronic device 800. For instance, the sensor component 814 may detect an on/off status of the electronic device 800 and relative positioning of components, such as a display and small keyboard of the electronic device 800, and the sensor component 814 may further detect a change in a position of the electronic device 800 or a component of the electronic device 800, presence or absence of contact between the user and the electronic device 800, orientation or acceleration/deceleration of the electronic device 800 and a change in temperature of the electronic device 800. The sensor component 814 may include a proximity sensor configured to detect presence of an object nearby without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the electronic device 800 and another device. The electronic device 800 may access a communication-standard-based wireless network, such as a Wireless Fidelity (Wi-Fi) network, a 2nd-Generation (2G) or 3rd-Generation (3G) network or a combination thereof. In an exemplary embodiment, the communication component 816 receives a broadcast signal or broadcast associated information from an external broadcast management system through a broadcast channel. In an exemplary embodiment, the communication component 816 further includes a Near Field Communication (NFC) module to facilitate short-range communication. For example, the NFC module may be implemented based on a Radio Frequency Identification (RFID) technology, an Infrared Data Association (IrDA) technology, an Ultra-Wide Band (UWB) technology, a Bluetooth (BT) technology and another technology.

In the exemplary embodiment, the electronic device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In the exemplary embodiment, a nonvolatile computer-readable storage medium is also provided, for example, a memory 804 including computer program instructions. The computer program instructions may be executed by a processor 820 of an electronic device 800 to implement the abovementioned method.

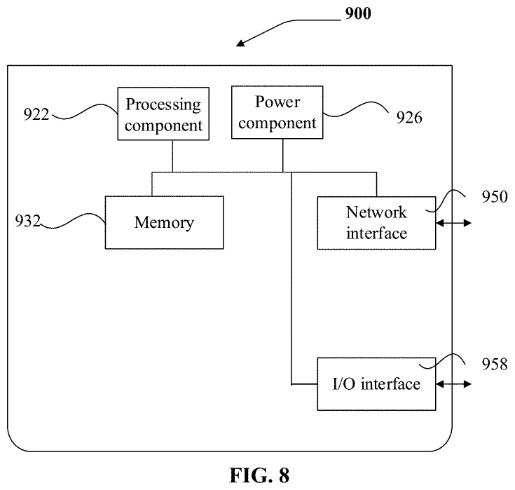

FIG. 8 is a block diagram of an electronic device 900 according to an exemplary embodiment. For example, the electronic device 900 may be provided as a server. Referring to FIG. 8, the electronic device 900 includes a processing component 922, further including one or more processors, and a memory resource represented by a memory 932, configured to store instructions executable for the processing component 922, for example, an application program. The application program stored in the memory 932 may include one or more than one module of which each corresponds to a set of instructions. In addition, the processing component 922 is configured to execute the instructions to execute the abovementioned method.

The electronic device 900 may further include a power component 926 configured to execute power management of the electronic device 900, a wired or wireless network interface 950 configured to concatenate the electronic device 1900 to a network and an I/O interface 958. The electronic device 900 may be operated based on an operating system stored in the memory 932, for example, Windows Server™, Mac OS X™, Unix™, Linux™, FreeBSD™ or the like.

In the exemplary embodiment, a nonvolatile computer-readable storage medium is also provided, for example, a memory 932 including computer program instructions. The computer program instructions may be executed by a processing component 922 of an electronic device 900 to implement the abovementioned method.

The disclosure may be a system, a method and/or a computer program product. The computer program product may include a computer-readable storage medium, in which computer-readable program instructions configured to enable a processor to implement each aspect of the disclosure is stored.

The computer-readable storage medium may be a physical device capable of retaining and storing instructions used by an instruction execution device. For example, the computer-readable storage medium may be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a Random Access Memory (RAM), a ROM, an EPROM (or a flash memory), an SRAM, a Compact Disc Read-Only Memory (CD-ROM), a Digital Video Disk (DVD), a memory stick, a floppy disk, a mechanical encoding device, a punched card or in-slot raised structure with instructions stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instruction described here may be downloaded from the computer-readable storage medium to each computing/processing device or downloaded to an external computer or an external storage device through a network such as the Internet, a Local Area Network (LAN), a Wide Area Network (WAN) and/or a wireless network. The network may include a copper transmission cable, optical fiber transmission, wireless transmission, a router, a firewall, a switch, a gateway computer and/or an edge server. A network adapter card or network interface in each computing/processing device receives the computer-readable program instruction from the network and forwards the computer-readable program instruction for storage in the computer-readable storage medium in each computing/processing device.

The computer program instruction configured to execute the operations of the disclosure may be an assembly instruction, an Instruction Set Architecture (ISA) instruction, a machine instruction, a machine related instruction, a microcode, a firmware instruction, state setting data or a source code or target code edited by one or any combination of more programming languages, the programming language including an object-oriented programming language such as Smalltalk and C++ and a conventional procedural programming language such as “C” language or a similar programming language. The computer-readable program instruction may be completely executed in a computer of a user or partially executed in the computer of the user, executed as an independent software package, executed partially in the computer of the user and partially in a remote computer, or executed completely in the remote server or a server. Under the condition that the remote computer is involved, the remote computer may be concatenated to the computer of the user through any type of network including an LAN or a WAN, or, may be concatenated to an external computer (for example, concatenated by an Internet service provider through the Internet). In some embodiments, an electronic circuit such as a programmable logic circuit, an FPGA or a Programmable Logic Array (PLA) may be customized by use of state information of a computer-readable program instruction, and the electronic circuit may execute the computer-readable program instruction, thereby implementing each aspect of the disclosure.

Herein, each aspect of the disclosure is described with reference to flowcharts and/or block diagrams of the method, device (system) and computer program product according to the embodiments of the disclosure. It is to be understood that each block in the flowcharts and/or the block diagrams and a combination of each block in the flowcharts and/or the block diagrams may be implemented by computer-readable program instructions.

These computer-readable program instructions may be provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and through these instructions, the computer, the programmable data processing device and/or another device may work in a specific manner, so that the computer-readable medium including the instructions includes a product including instructions for implementing each aspect of the function/action specified in one or more blocks in the flowcharts and/or the block diagrams.

These computer-readable program instructions may further be loaded to the computer, the other programmable data processing device or the other device, so that a series of operating steps are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

The flowcharts and block diagrams in the drawings illustrate probably implemented system architectures, functions and operations of the system, method and computer program product according to multiple embodiments of the disclosure. On this aspect, each block in the flowcharts or the block diagrams may represent part of a module, a program segment or an instruction, and part of the module, the program segment or the instruction includes one or more executable instructions configured to realize a specified logical function. In some alternative implementations, the functions marked in the blocks may also be realized in a sequence different from those marked in the drawings. For example, two continuous blocks may actually be executed substantially concurrently and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and a computer instruction.

Different embodiments of the application may be combined without departing from logics, different embodiments are described with different emphases, and emphasized parts may refer to records in the other embodiments. Each embodiment of the disclosure has been described above. The above descriptions are exemplary, non-exhaustive and also not limited to each disclosed embodiment. Many modifications and variations are apparent to those of ordinary skill in the art without departing from the scope and spirit of each described embodiment of the disclosure. The terms used herein are selected to explain the principle and practical application of each embodiment or technical improvements in the technologies in the market best or enable others of ordinary skill in the art to understand each embodiment disclosed herein.

What is claimed is:

1. An image processing method, comprising:
acquiring a color feature extracted from a first image;
acquiring a customized mask feature, the customized mask feature being configured to indicate a regional position of the color feature in the first image; and
inputting the color feature and the customized mask feature to a feature mapping network to perform image attribute edition to obtain a second image.

2. The method of claim 1, wherein the feature mapping network is a feature mapping network obtained by training, and
a training process for the feature mapping network comprises:
determining a data pair formed by first image data and a mask feature corresponding to the first image data as a training dataset;
inputting the training dataset to the feature mapping network;
mapping, in the feature mapping network, a color feature of at least one block in the first image data to a feature corresponding to the block to output second image data;
obtaining a first loss function according to the second image data and the first image data;
performing generative adversarial processing through back propagation of the first loss function, and
ending the training process when the feature mapping network converges.

3. The method of claim 2, wherein mapping, in the feature mapping network, the color feature of the at least one block in the first image data to the corresponding mask feature to output the second image data comprises:
inputting the color feature of the at least one block and the corresponding mask feature to a Spatial-Aware Style encoder in the feature mapping network;
fusing the color feature provided by the first image data and a spatial feature provided by the corresponding mask feature through the Spatial-Aware Style encoder to obtain a fused image feature configured to represent the spatial and color features; and
inputting the fused image feature and the corresponding mask feature to an image generation part to obtain the second image data.

4. The method of claim 3, wherein inputting the fused image and the corresponding mask feature to the image generation part to obtain the second image data comprises:
inputting the fused image feature to the image generation part;
transforming, through the image generation part, the fused image feature to a corresponding affine parameter, the affine parameter comprising a first parameter and a second parameter;
inputting the corresponding mask feature to the image generation part to obtain a third parameter; and
obtaining the second image data according to the first parameter, the second parameter and the third parameter.

5. The method of claim 2, further comprising:
inputting the mask feature, corresponding to the first image data, in the training dataset to a mask variational auto-encoder to perform training to output two sub mask changes.

6. The method of claim 5, wherein inputting the mask feature, corresponding to the first image data, in the training dataset to the mask variational auto-encoder to perform training to output the two sub mask changes comprises:
obtaining a first mask feature and a second mask feature from the training dataset, the second mask feature being different from the first mask feature;
performing encoding processing through the mask variational auto-encoder to map the first mask feature and the second mask feature to a preset feature space respectively to obtain a first intermediate variable and a second intermediate variable, the preset feature space being lower than the first mask feature and the second mask feature in dimension;
obtaining, according to the first intermediate variable and the second intermediate variable, two third intermediate variables corresponding to the two sub mask changes; and
performing decoding processing through the mask variational auto-encoder to transform the two third intermediate variables to the two sub mask changes.

7. The method of claim 5, wherein the method further comprises a simulation training process for face edition processing,
wherein the simulation training process comprises:
inputting the mask feature, corresponding to the first image data, in the training dataset to the mask variational auto-encoder to output the two sub mask changes;
inputting the two sub mask changes to two feature mapping networks respectively, the two feature mapping networks sharing a group of shared weights, and updating weights of the feature mapping networks to output two pieces of image data;
determining fused image data obtained by fusing the two pieces of image data as the second image data;
obtaining a second loss function according to the second image data and the first image data;
performing generative adversarial processing through back propagation of the second loss function; and
ending the simulation training process when the feature mapping network converges.

8. An electronic device, comprising:
a processor; and
a memory, configured to store instructions executable for the processor.
wherein when the instructions are executed by the processor, the processor is configured to:
acquire a color feature extracted from a first image;
acquire a customized mask feature, the customized mask feature being configured to indicate a regional position of the color feature in the first image; and
input the color feature and the customized mask feature to a feature mapping network to perform image attribute edition to obtain a second image.

9. The electronic device of claim 8, wherein the feature mapping network is a feature mapping network obtained by training, and
the processor is further configured to:
determine a data pair formed by first image data and a mask feature corresponding to the first image data as a training dataset; and
input the training dataset to the feature mapping network, map, in the feature mapping network, a color feature of at least one block in the first image data to the corresponding mask feature to output second image data, obtain a first loss function according to the second image data and the first image data, perform generative adversarial processing through back propagation of the first loss function, and end a training process of the feature mapping network when the feature mapping network converges.

10. The electronic device of claim 9, wherein the processor is further configured to:
input the color feature of the at least one block and the corresponding mask feature to a Spatial-Aware Style encoder in the feature mapping network;
fuse the color feature provided by the first image data and a spatial feature provided by the corresponding mask feature through the Spatial-Aware Style encoder to obtain a fused image feature configured to represent the spatial and color features; and
input the fused image feature and the corresponding mask feature to an image generation part to obtain the second image data.

11. The electronic device of claim 10, wherein the processor is further configured to:
input the fused image feature to the image generation part;
transform, through the image generation part, the fused image feature to a corresponding affine parameter, the affine parameter comprising a first parameter and a second parameter;
input the corresponding mask feature to the image generation part to obtain a third parameter; and
obtain the second image data according to the first parameter, the second parameter and the third parameter.

12. The electronic device of claim 9, wherein the processor is further configured to:
input the mask feature, corresponding to the first image data, in the training dataset to a mask variational auto-encoder to perform training to output two sub mask changes.

13. The electronic device of claim 12, wherein the processor is further configured to:
obtain a first mask feature and a second mask feature from the training dataset, the second mask feature being different from the first mask feature;
perform encoding processing through the mask variational auto-encoder to map the first mask feature and the second mask feature to a preset feature space respectively to obtain a first intermediate variable and a second intermediate variable, the preset feature space being lower than the first mask feature and the second mask feature in dimension;
obtain, according to the first intermediate variable and the second intermediate variable, two third intermediate variables corresponding to the two sub mask changes; and
perform decoding processing through the mask variational auto-encoder to transform the two third intermediate variables to the two sub mask changes.

14. The electronic device of claim 12, wherein the processor is further configured to:
input the mask feature corresponding to the first image data in the training dataset to the mask variational auto-encoder to output the two sub mask changes;
input the two sub mask changes to two feature mapping networks respectively, the two feature mapping networks sharing a group of shared weights, and update weights of the feature mapping networks to output two pieces of image data;
determine fused image data obtained by fusing the two pieces of image data as the second image data;
obtain a second loss function according to the second image data and the first image data;
perform generative adversarial processing through back propagation of the second loss function; and
end a simulation training process for face edition processing when the feature mapping network converges.

15. A non-transitory computer-readable storage medium, in which computer program instructions are stored, the computer program instructions being executed by a processor to perform:
acquiring a color feature extracted from a first image;
acquiring a customized mask feature, the customized mask feature being configured to indicate a regional position of the color feature in the first image; and
inputting the color feature and the customized mask feature to a feature mapping network to perform image attribute edition to obtain a second image.

16. The non-transitory computer-readable storage medium of claim 15, wherein the feature mapping network is a feature mapping network obtained by training, and
a training process for the feature mapping network comprises:
determining a data pair formed by first image data and a mask feature corresponding to the first image data as a training dataset;
inputting the training dataset to the feature mapping network;
mapping, in the feature mapping network, a color feature of at least one block in the first image data to a feature corresponding to the block to output second image data;
obtaining a first loss function according to the second image data and the first image data;
performing generative adversarial processing through back propagation of the first loss function, and
ending the training process when the feature mapping network converges.

17. The non-transitory computer-readable storage medium of claim 16, wherein mapping, in the feature mapping network, the color feature of the at least one block in the first image data to the corresponding mask feature to output the second image data comprises:
inputting the color feature of the at least one block and the corresponding mask feature to a Spatial-Aware Style encoder in the feature mapping network;
fusing the color feature provided by the first image data and a spatial feature provided by the corresponding mask feature through the Spatial-Aware Style encoder to obtain a fused image feature configured to represent the spatial and color features; and
inputting the fused image feature and the corresponding mask feature to an image generation part to obtain the second image data.

18. The non-transitory computer-readable storage medium of claim 17, wherein inputting the fused image and the corresponding mask feature to the image generation part to obtain the second image data comprises:
inputting the fused image feature to the image generation part;
transforming, through the image generation part, the fused image feature to a corresponding affine parameter, the affine parameter comprising a first parameter and a second parameter;
inputting the corresponding mask feature to the image generation part to obtain a third parameter; and
obtaining the second image data according to the first parameter, the second parameter and the third parameter.

19. The non-transitory computer-readable storage medium of claim 16, wherein the computer program instructions are executed by the processor to further perform:
inputting the mask feature, corresponding to the first image data, in the training dataset to a mask variational auto-encoder to perform training to output two sub mask changes.

20. The non-transitory computer-readable storage medium of claim 19, wherein inputting the mask feature, corresponding to the first image data, in the training dataset to the mask variational auto-encoder to perform training to output the two sub mask changes comprises:
obtaining a first mask feature and a second mask feature from the training dataset, the second mask feature being different from the first mask feature;
performing encoding processing through the mask variational auto-encoder to map the first mask feature and the second mask feature to a preset feature space respectively to obtain a first intermediate variable and a second intermediate variable, the preset feature space being lower than the first mask feature and the second mask feature in dimension;
obtaining, according to the first intermediate variable and the second intermediate variable, two third intermediate variables corresponding to the two sub mask changes; and
performing decoding processing through the mask variational auto-encoder to transform the two third intermediate variables to the two sub mask changes.
